(19) United States
(12) Patent Application Publication
(10) Pub. No.: US 2003/0120630 A1
(43) Pub. Date: Jun. 26, 2003

(54) Method and system for similarity search and clustering

(76) Inventor: Daniel Tunkelang, Cambridge, MA (US)

Correspondence Address: HALE AND DORR, LLP, 60 STATE STREET, BOSTON, MA, 02109

(21) Appl. No.: 10/027,195

(22) Filed: Dec. 20, 2001

(51) Int. Cl. G06F 7/00

(52) U.S. Cl. 707/1

(57) ABSTRACT

Provided is a similarity search method that makes use of a localized distance metric. The data includes a collection of items, wherein each item is associated with a set of properties. The distance between two items is defined in terms of the number of items in the collection that are associated with the set of properties common to the two items. A query is generally composed of a set of properties. The distance between a query and an item is defined in terms of the number of items in the collection that are associated with the set of properties common to the query and the item. The properties can be of various types, such as binary, partially ordered, or numeric. The distance metric may be applied explicitly or implicitly for similarity search. One embodiment of this invention uses random walks such that the similarity search can be performed exactly or approximately, trading-off between accuracy and performance. The distance metric of the present invention can also be the basis for matching and clustering applications. In these contexts, the distance metric of the present invention may be used to build a graph, to which matching or clustering algorithms can be applied.

### FIELD OF THE INVENTION

The present invention relates to similarity search, generally for searching databases, and to the clustering and matching of items in a database. Similarity search is also referred to as nearest neighbor search or proximity search.

### BACKGROUND OF THE INVENTION

Similarity search is directed to identifying items in a collection of items that are similar to a given item or specification. Similarity search has numerous applications, ranging from recommendation engines for electronic commerce (e.g., providing the capability to show a user books that are similar to a book she bought and liked) to search engines for bioinformatics (e.g., providing the capability to show a user genes that have similar characteristics to a gene with known properties).

Conventionally, the similarity search problem has been defined in terms of Euclidean geometric distance in Euclidean space. The Euclidean geometric approach has been widely applied to similarity search since its use in very early work relating to similarity search. The divide-and-conquer method for calculating the nearest neighbors of a point in a two-dimensional geometric space proposed in M. I. Shamos and D. Hoey, “Closest-Point Problems” in Proceedings of the 6^{th} Annual Symposium on Foundations of Computer Science, IEEE, 1975, is an example of such early work, in this case, in two dimensions.

Later work generalized the similarity search problem beyond two-dimensional spaces to geometric spaces of higher dimension. For example, the indexing structure proposed in A. Guttman, “R-Trees: A Dynamic Index Structure for Spatial Searching” in Proceedings of the ACM SIG-MOD Conference, 1984, provides a general method to address similarity search for low-dimensional geometric data.

Similarity search of high-dimensional geometric data imposes great demands on resources and raises performance problems. Indexing structures like R-trees perform poorly for high-dimensional spaces and are generally outperformed by brute-force approaches (i.e., scanning through the entire data set) when the number of dimensions reaches 30 (or even fewer). This problem is known as the “curse of dimensionality.” The cost of brute-force approaches is proportional to the size of the data set, making them impractical for applications that need to provide interactive response times for similarity searches on large data sets.

More recent work suggests that, even if it is possible to solve the performance problems and build an apparatus that efficiently solves the similarity search problem for high-dimensional geometric data, there may still be a quality problem with the results, namely, that the output of such an apparatus may hold little value for real-world data. The reason for this problem is discussed in K. Beyer, J. Goldstein, R. Ramakrishnan, U. Shaft, “When is nearest neighbor meaningful?” in Proceedings of the 7^{th} International Conference on Database Theory, 1999. In summary, under a broad set of conditions, as dimensionality increases, the distance from the given data point to the nearest data point in the collection approaches the distance to the farthest data point, thereby making the notion of a nearest neighbor meaningless.

The conventional, Euclidean geometric model's reliance on geometric terms to define nearest neighbors and nearest neighbor search constrains the generality of the model. In particular, in accordance with the model, a collection of materials on which a similarity search is to be performed is presumed to consist of a collection of points in a Euclidean space of n dimensions [symbol] ⁿ. When n is 2 or 3, this space may have a literal geometric interpretation, corresponding to a two or three-dimensional physical reality. In many applications, however, the collection of materials is not located in a physical space. Rather, typically each item in the collection is associated with up to n properties, and the properties are mapped to n real-valued dimensions to form the Euclidean space [symbol] ⁿ Each item maps to a point in [symbol] ⁿ, which may be represented by a vector.

This mapping can pose many problems. Properties of items in the collection may not naturally map to real-valued dimensions. In particular, a property may take on a set of discrete unordered values, e.g., gender is one of {male, female}. Such values do not translate naturally into real-valued dimensions. Also, in general, the values for different properties, even if they are real-valued, may not be in the same units. Accordingly, normalization of properties is another issue.

Another significant issue with the Euclidean geometric model arises from correlations among the properties. The Euclidean distance metric in [symbol] ⁿ is applicable when the n dimensions are independent and identically distributed. Normalization may overcome a lack of identical distribution, but normalization generally does not address dependence among the properties. Properties can exhibit various types of dependence. One strong type of dependence is implication. Two properties are related by implication if the presence of property X implies the presence of property Y. For example, Location: North Pole implies Climate: Frigid, defining a dependency. Many dependencies, however, are far more subtle. Dependencies may involve more than two properties, and the collection of dependencies for a collection of materials may be difficult to detect and impractical to enumerate. Even if the dimensions are normalized, a Euclidean distance metric factors in each property independently in determining the distance between two items. As a result, dependencies can reduce the usefulness of the Euclidean geometric approach with the Euclidean distance metric for the similarity search problem.

For example, a model of a collection of videos might represent each video as a vector based on the actors who play major roles in it. In a Euclidean geometric model, each actor would be mapped to his or her own dimension, i.e., there would be as many dimensions in the space as there are distinct actors represented in the collection of videos. One assumption that could be made to simplify the model is that the presence of an actor in a video is binary information, i.e., the only related information available in the model is whether or not a given actor played a major role in a given video. Hence, each video would be represented as an n-dimensional vector of 0/1 values, n being the number of actors in the collection. A video starring Aaron Eckhart, Matt Mallow, and Stacy Edwards, for example, would be represented as a vector in [symbol] ⁿ containing values of 1 for the dimensions corresponding to those three actors, and values of 0 for all other dimensions.

While this vector representation seems reasonable in principle, it poses problems for similarity search. The distance between two videos is a function of how many actors the two videos have in common. Typically, the distance would be defined as being inversely related to the number of actors the two videos have in common. This distance function causes problems when a set of actors tends to act in many of the same videos. For example, a video starring William Shatner is likely also to star Leonard Nimoy, DeForest Kelley, and the rest of the Star Trek regulars. Indeed, any two Star Trek videos are likely to have a dozen actors in common. In contrast, two videos in a series with fewer regular actors (e.g., Star Wars) would be further apart according to this Euclidean distance function, even though the Star Trek movies are not necessarily more “similar” than the Star Wars movies. The dependence between the actors in the Star Trek movies is such that they should almost be treated as a single actor.

One approach to patch this problem is to normalize the dimensions. Such an approach would transform the n dimensions by assigning a weight to each actor, i.e., making certain actors in the collection count more than others. Thus, two videos having a heavily-weighted actor in common would be accorded more similarity than two videos having a less significant actor in common.

Such an approach, however, generally only addresses isolated dependencies. If the set of actors can be cleanly partitioned into disjoint groups of actors that always act together, then normalization will be effective. The reality, however, is that actors cannot be so cleanly partitioned. Actors generally belong to multiple, non-disjoint groups, and these groups do not always act together. In other words, there are complex dependencies. Even with normalization, a Euclidean distance metric may not accurately model data that exhibits these kinds of dependencies. Normalization does not account for context. And such dependencies are the rule, rather than the exception, in real-world data.

Modifications to the Euclidean geometric model and the Euclidean distance metric may be able to address some of these shortcomings. A. Hinneburg, C. Aggarwal, and D. Keim, “What is the nearest neighbor in high dimensional spaces?” in Proceedings of the 26^{th} VLDB Conference, 2000, has proposed a variation on the conventional definition of similarity search to address the problem of dependencies. The method of Hinneburg et al. uses a heuristic to project the data set onto a low-dimensional subspace whose dimensions are chosen based on the point on which the similarity search is being performed. Because this approach is grounded in Euclidean geometry, it still incorporates some inherent disadvantages of Euclidean approaches.

The clustering problem is related to the similarity search problem. The clustering problem is that of partitioning a set of items into clusters so that two items in the same cluster are more similar than two items in different clusters. Most mathematical formulations of the clustering problem reduce to NP-complete decision problems, and hence it is not believed that there are efficient algorithms that can guarantee optimal solutions. Existing solutions to the clustering problem generally rely on the types of geometric algorithms discussed above to determine the degree of similarity between items, and are subject to their limitations.

The matching problem is also related to the similarity search problem. The matching problem is that of pairing up items from a set of items so that a pair of items that are matched to each other are more similar than two items that are not matched to each other. There are two kinds of matching problems: bipartite and non-bipartite. In a bipartite matching problem, the items are divided into two disjoint and preferably equal-sized subsets; the goal is to match each item in the first subset to an item in the second subset. Non-bipartite matching is a special case of clustering. Existing solutions to the matching problem generally rely on the types of geometric algorithms discussed above to determine the degree of similarity between items, and are subject to their limitations.

### SUMMARY OF THE INVENTION

The present invention is directed to a similarity search method and system that use an alternative, non-Euclidean approach, are applicable to a variety of types of data sets, and return results that are meaningful for real-world data sets. The invention operates on a collection of items, each of which is associated with one or more properties. The invention employs a distance metric defined in terms of the distance between two sets of properties. The distance metric is defined by a function that is correlated to the number of items in the collection that are associated with properties in the intersection of the two sets of properties. If the number of items is low, the distance will typically be low; and if the number of items is high, the distance will typically be high. In one distance function in accordance with the invention, the distance is equivalent to the number of items in the collection that are associated with all of the properties in the intersection of the two sets of properties. For identifying the nearest neighbors of a single item or a group of items in a collection of items, the distance metric is applied between the set of properties associated with the reference item or items and the sets of properties associated with the other items in the collection, generally individually. The items may then be ordered in accordance with their distances from the reference in order to determine the nearest neighbors of the reference.

The invention has broad applicability and is not generally limited to certain types of items or properties. The invention addresses some of the weaknesses of the Euclidean geometric approach. The present invention does not depend on algorithms that compute nearest neighbors based on Euclidean or other geometric distance measures. The similarity search process of the present invention provides meaningful outputs even for some data sets that may not be effectively searchable using Euclidean geometric approaches, such as high-dimensional data sets. The present invention has particular utility in addressing the quality and performance problems that confront existing approaches to the similarity search problem.

A search system in accordance with the present invention implements the method of the present invention. In exemplary embodiments of the invention, the system performs a similarity search for a reference item or plurality of items on a collection of items contained within a database in which each item is associated with one or more properties. Embodiments of the search system preferably allow a user to identify a reference item or group of items or a set of properties to initiate a similarity search query. The result of the similarity search includes the nearest neighbors of the reference item or items, that is, the items closest to the reference item or items, in accordance with the distance function of the system. Some embodiments of a search system in accordance with the present invention preferably identify items whose distance from the reference item or group of items is equal to or lower than an explicit or implicit threshold value as the nearest neighbors of the reference.

In another aspect of the invention, embodiments of the search system preferably also support use of a query language that enables a general query for all items associated with a desired set of one or more properties. The result for such a query is the set of such items. In terms of the query language function, if two items are in the collection of items, than the distance between them, in accordance with the particular distance function described above, is the smallest number of items returned by any of the queries whose results include both items.

In embodiments of the invention, multidimensional data sets may be encoded in a variety of ways, depending on the nature of the data. In particular, properties may be of various types, such as binary, partially ordered, or numerical. The vector for an item (i.e., data point) may be composed of numbers, binary values, or values from a partially-ordered set. The present invention may be adapted to a wide variety of numerical and non-numerical data types.

In another aspect of the invention, the similarity search method and system of the present invention also form a building block for matching and clustering methods. Matching and clustering applications may be implemented, for example, by representing a set of materials either explicitly or implicitly as a graph, in which the nodes represent the materials and the edges connecting nodes have weights that represent the degree of similarity or dissimilarity of the materials corresponding to their endpoints. In these applications, the similarity search method and system of the present invention can be used to determine the edge weights of such a graph. Once such weights are assigned (explicitly or implicitly), matching or clustering algorithms can be applied to the graph.

### BRIEF DESCRIPTION OF THE DRAWINGS

The invention may be further understood from the following description and the accompanying drawings, wherein:

FIG. 1 is a diagram that depicts a partial order as a directed acyclic graph.

FIG. 2 is a diagram that depicts a partial order of numerical ranges as a directed acyclic graph.

FIG. 3 is a diagram that illustrates the set of all subsets of reference properties for a search reference movie in a movie catalog.

FIG. 4 is a diagram that depicts an embodiment of the present invention as a flow chart.

FIG. 5 is a diagram that depicts an architecture for an embodiment of the present invention.

### DETAILED DESCRIPTION OF PREFERRED EMBODIMENTS

Embodiments of the present invention represent items as sets of properties, rather than as vectors in [symbol] ⁿ This representation as sets of properties is widely applicable to many types of properties and does not require a general transformation of non-numerical properties into real numbers. A particular item's relationship with a particular property in the system may simply be represented as a binary variable.

For example, this representation may be applied to properties that can be related by a partial order. A partial order is a relationship among a set of properties that satisfies the following conditions:

i. Given two distinct properties X and Y, exactly one of the following is true:

1. X is an ancestor of Y (written as either X>Y or Y<X)

2. Y is an ancestor of X (written as either X<Y or Y>X)

3. X and Y are incomparable (written as X<>Y)

ii. The partial order is transitive: if X>Y and Y>Z, then X>Z.

There are numerous examples of partial orders in real-world data sets. For example, in a database of technical literature, subject areas could be represented in a partial order. This partial order could include relationships such as:

Mathematics>Algorithms

Mathematics>Algebra

Algebra>Linear Algebra

Computer Science>Operating Systems

Computer Science>Artificial Intelligence

Computer Science>Algorithms

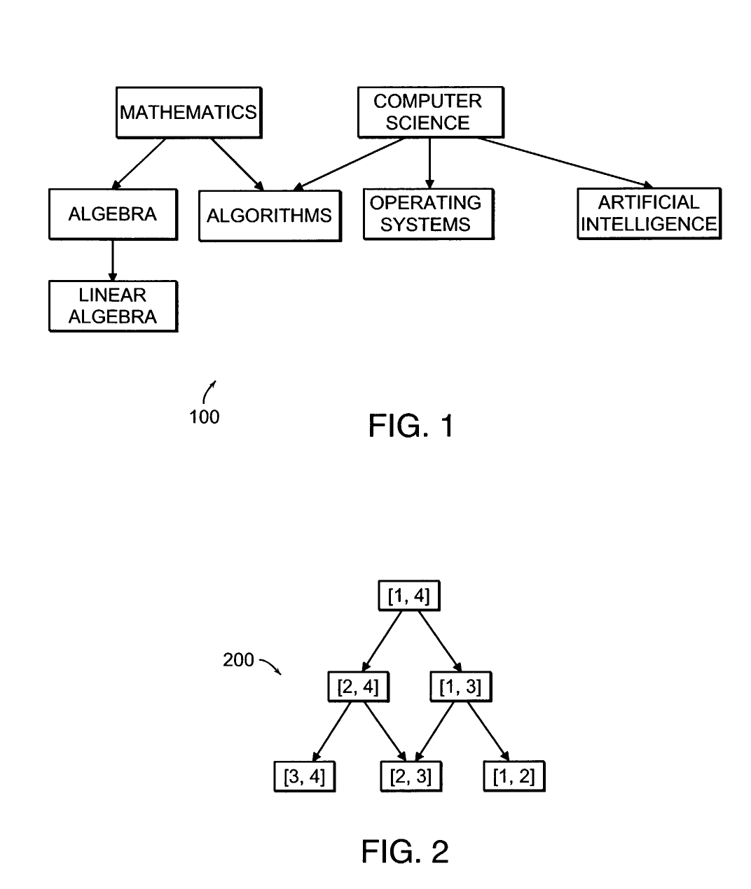

Transitivity further implies that Mathematics>Linear Algebra. Many pairs of properties are incomparable, e.g., Linear Algebra<>Algorithms. The diagram in FIG. 1 depicts the partial order described above as a directed acyclic graph 100.

Numerical ranges also have a natural partial order. Given two distinct numerical ranges [x, y] and [x′, y′], [x, y]>[x′, y′] if x≦x′ and y≧y′. For example:

[1, 4]>[1, 3]

[1, 4]>[2, 4]

[1, 3]>[1, 2]

[1, 3]>[2, 3]

[2, 4]>[2, 3]

[2, 4]>[3, 4]

Transitivity also implies that [1, 4]>[2, 3]. An example of an incomparable pair of ranges is that [1, 3]<>[2, 4]. The diagram in FIG. 2 depicts the partial order of numerical ranges described above as a directed acyclic graph 200.

In some embodiments of the invention, partially-ordered properties are addressed by augmenting each item's property set with all of the ancestors of its properties. For example, an item associated with Linear Algebra would also be associated with Algebra and Mathematics. In accordance with preferred embodiments of the invention, all property sets discussed hereinbelow are assumed to be augmented, that is, if a property is in a set, then so are all of that property's ancestors.

The distance between items is analyzed in terms of their property sets. One aspect of the present invention is the distance metric used for determining the distance between two property sets. A distance metric in accordance with the invention may be defined as follows: given two property sets S₁ and S₂, the distance between S₁ and S₂ is equal to the number of items associated with all of the properties in the intersection S₁∩S₂. In accordance with this metric, the distance between two items will be at least 2 and at most the number of items in the collection. This distance metric is used for the remainder of the detailed description of the preferred embodiments, but it should be understood that variations of this measure would achieve similar results. For example, distance metrics based on functions correlated to the number of items associated with all of the properties in the intersection S₁∩S₂ could also be used.

This distance metric accounts for the similarity between items based not only on the common occurrence of properties, but also their frequency. In addition, this distance metric is meaningful in part because it captures the dependence among properties in the data. Normalized Euclidean distance metrics may take the frequency of properties into account, but they consider each property independently. The distance metric of the present invention takes into account the frequencies of combinations of properties. For example, Lawyer, College Graduate, and High-School Dropout may all be frequently occurring properties, but the combination Lawyer+College Graduate is much more frequent than the combination Lawyer+High-School Dropout. Thus, two lawyers who both dropped out of high school would be considered more similar than two lawyers who both graduated from college. Such an observation can be made if the distance metric takes into account the dependence among properties. In general, not all of the properties in the data will be useful for similarity search. For example, two people who share February 29^{th} as a birthday may be part of a select group, but it is unlikely that this commonality reveals any meaningful similarity. Hence, in certain embodiments of the present invention, only properties deemed meaningful for assessing similarity are taken into account by the similarity search method. Properties that are deemed irrelevant to the search can be ignored.

An example based on a movie catalog will be used to demonstrate how the distance metric may be applied to a collection of items. In such a catalog, a collection of movies could be represented with the following property sets:

1. Die Hard

Director: John McTiernan

Star: Bruce Willis

Star: Bonnie Bedelia

Genre: Action

Genre: Thriller

Series: Die Hard

2. Die Hard 2

Director: Renny Harlin

Star: Bruce Willis

Genre: Action

Genre: Thriller

Series: Die Hard

3. Die Hard: With a Vengeance

Director: John McTiernan

Star: Bruce Willis

Star: Samuel L. Jackson

Genre: Action

Genre: Thriller

Series: Die Hard

4. Star Wars

Director: George Lucas

Star: Mark Hamill

Star: Harrison Ford

Genre: Sci-Fi

Genre: Action

Genre: Adventure

Series: Star Wars

5. Star Wars: Empire Strikes Back

Director: Irvin Kershner

Star: Mark Hamill

Star: Harrison Ford

Genre: Sci-Fi

Genre: Action

Genre: Adventure

Series: Star Wars

6. Star Wars: Return of the Jedi

Director: Richard Marquand

Star: Mark Hamill

Star: Harrison Ford

Genre: Sci-Fi

Genre: Action

Genre: Adventure

Series: Star Wars

7. Star Wars: The Phantom Menace

Director: George Lucas

Star: Liam Neeson

Star: Ewan McGregor

Star: Natalie Portman

Genre: Sci-Fi

Genre: Action

Genre: Adventure

Series: Star Wars

8. Raiders of the Lost Ark

Director: Stephen Spielberg

Star: Harrison Ford

Star: Karen Allen

Genre: Action

Genre: Adventure

Series: Indiana Jones

9. Indiana Jones and the Temple of Doom

Director: Stephen Spielberg

Star: Harrison Ford

Star: Kate Capshaw

Genre: Action

Genre: Adventure

Series: Indiana Jones

10. Indiana Jones and the Last Crusade

Director: Stephen Spielberg

Star: Harrison Ford

Star: Sean Connery

Genre: Action

Genre: Adventure

Series: Indiana Jones

11. Close Encounters of the Third Kind

Director: Stephen Spielberg

Star: Richard Dreyfuss

Star: Francois Truffaut

Genre: Drama

Genre: Sci-Fi

12. E. T.: the Extra-Terrestrial

Director: Stephen Spielberg

Star: Dee Wallace-Stone

Star: Henry Thomas

Genre: Family

Genre: Sci-Fi

Genre: Adventure

13. Until the End of the World

Director: Wim Wenders

Star: Solveig Dommartin

Star: Pietro Falcone

Genre: Drama

Genre: Sci-Fi

14. Wings of Desire

Director: Wim Wenders

Star: Solveig Dommartin

Star: Bruno Ganz

Genre: Drama

Genre: Fantasy

Genre: Romance

15. Buena Vista Social Club

Director: Wim Wenders

Star: Ry Cooder

Genre: Documentary

Presumably a real movie catalog would contain far more than 15 movies, but the above collection serves as an illustrative example.

The distance between Die Hard and Die Hard 2 is computed as follows. The intersection of their property sets is {Star: Bruce Willis, Genre: Action, Genre: Thriller, Series: Die Hard}. All three movies in the Die Hard series (but no other movies in this sample catalog) have all of these properties. Hence, the distance between the two movies is 3.

In contrast, Die Hard and Die Hard With a Vengeance also have the same director. The intersection of their property sets is {Director: John McTiernan, Star: Bruce Willis, Genre: Action, Genre: Thriller, Series: Die Hard}. Only these two movies share all of these properties; hence, the distance between the two movies is 2.

The above movies are obviously very similar. An example of two very dissimilar movies is Star Wars and Buena Vista Social Club. These two movies have no properties in common and the reference set of properties is the empty set; all of the movies in the collection can satisfy the reference set. Hence, the distance between the two movies is 15, i.e., the total number of movies in the collection.

An intermediate example is Star Wars: The Phantom Menace and E. T.: the Extra-Terrestrial. The intersection of their property sets is {Genre: Sci-Fi, Genre: Adventure}. Five movies have both of these properties (the four Star Wars movies and E. T.); hence, the distance between the two movies is 5.

Using the given distance metric, it is possible to order the movies according to their distance from a reference movie or from any property set. For example, the distances of all of the above movies from Die Hard are as follows:

1. Die Hard: 1

2. Die Hard 2: 3

3. Die Hard: With a Vengeance: 2

4. Star Wars: 10

5. Star Wars: Empire Strikes Back: 10

6. Star Wars: Return of the Jedi: 10

7. Star Wars: The Phantom Menace: 10

8. Raiders of the Lost Ark: 10

9. Indiana Jones and the Temple of Doom: 10

10. Indiana Jones and the Last Crusade: 10

11. Close Encounters of the Third Kind: 15

12. E. T.: the Extra-Terrestrial: 15

13. Until the End of the World: 15

14. Wings of Desire: 15

15. Buena Vista Social Club: 15

To summarize this distance ranking: the three movies in the Die Hard series are all within distance 3—Die Hard: With a Vengeance being at distance 2 because of the shared director—and the ten action movies are all within distance 10. The remaining movies have nothing in common with the reference, and are therefore at distance 15.

To further illustrate the distance ordering of items, the distances of all of the above movies from Raiders of the Lost Ark are as follows:

1. Die Hard: 10

2. Die Hard 2: 10

3. Die Hard: With a Vengeance: 10

4. Star Wars: 6

5. Star Wars: Empire Strikes Back: 6

6. Star Wars: Return of the Jedi: 6

7. Star Wars: The Phantom Menace: 10

8. Raiders of the Lost Ark: 1

9. Indiana Jones and the Temple of Doom: 3

10. Indiana Jones and the Last Crusade: 3

11. Close Encounters of the Third Kind: 5

12. E. T.: the Extra-Terrestrial: 5

13. Until the End of the World: 15

14. Wings of Desire: 15

15. Buena Vista Social Club: 15

In this case, the two other movies in the Indiana Jones series are at distance 3; the two Spielberg movies not in the Indiana Jones series are at distance 5; the three Star Wars movies with Harrison Ford are at distance 6; the remaining action movies are at distance 10; and the other movies are at distance 15.

In accordance with embodiments of the invention, the collection of items is preferably stored using a system that enables efficient computation of the subset of items in the collection containing a given set of properties.

A system based on inverted indexes could be used to implement such a system. An inverted index is a data structure that maps a property to the set of items containing it. For example, relational database management systems (RDBMS) use inverted indexes to map row values to the set of rows that have those values. Search engines also use inverted indexes to map words to the documents containing those words. The inverted indexes of an RDBMS, a search engine, or any other information retrieval system could be used to implement the method of the present invention.

In particular inverted indexes are useful for performing a conjunctive query—that is, to compute the subset of items in a collection that contain all of a given set of properties. This computation can be performed by obtaining, for each property, the set of items containing it, and then computing the intersection of those sets. This computation may be performed on demand, precomputed in advance, or computed on demand using partial information precomputed in advance.

An information retrieval system that provides a method for performing this computation efficiently is also described in co-pending applications: “Hierarchical Data-Driven Navigation System and Method for Information Retrieval,” U.S. appl. Ser. No. 09/573,305, filed May 18, 2000, and “Scalable Hierarchical Data-Driven Navigation System and Method for Information Retrieval,” U.S. appl. Ser. No. 09/961,131, filed Oct. 21, 2001, both of which have a common assignee with the present application, and which are hereby incorporated herein by reference.

Given a system like those described above, it is possible to compute the distance between two items in the collection—or between two property sets in general—by counting or otherwise evaluating the number of items in the collection containing all of the properties in the intersection of the two relevant property sets.

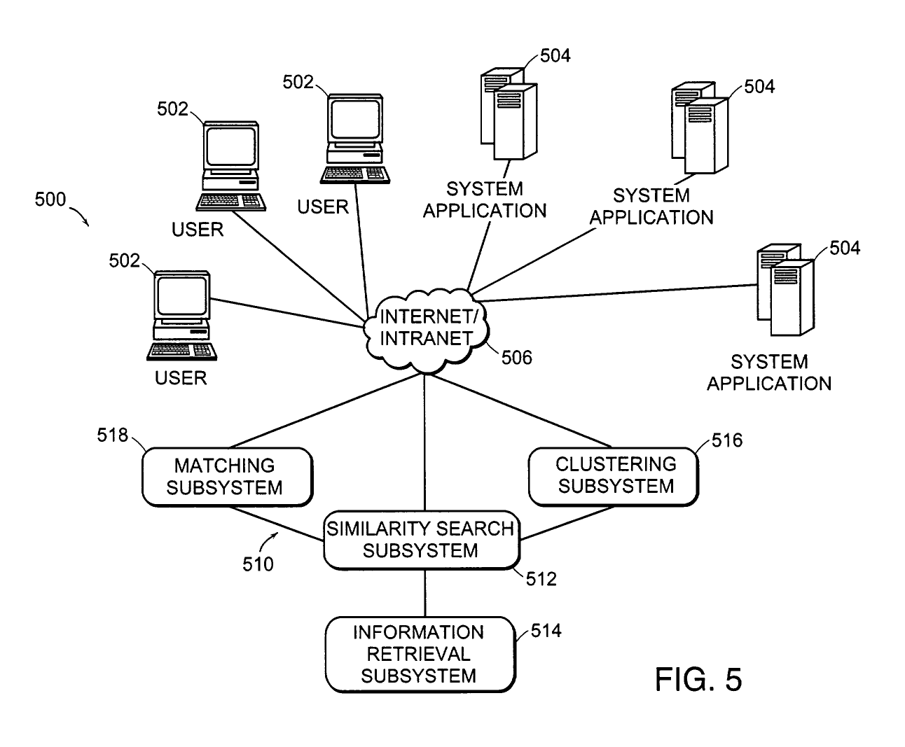

FIG. 5 is a diagram that depicts an architecture 500 that may be used to implement an embodiment of the present invention. It depicts a collection of users 502 and system applications 504 that use an internet or intranet 506 to access a system 510 that embodies the present invention. This system 510, in turn, is comprised of four subsystems, a subsystem for similarity search 512, a subsystem for information retrieval 514, a subsystem for clustering 516, and a subsystem for matching 518. As described above, similarity search may rely on the inverted indexes of the information retrieval subsystem. As described below, clustering and matching may rely on the similarity search subsystem.

As discussed earlier, the present invention allows the distance function to be correlated to, and optionally, but not necessarily, equal to, the number of items in the collection containing the intersection of the two relevant property sets. Such a function is practical as long as its value can be computed efficiently using a relational database or other information retrieval system.

This distance metric can be used to compute the nearest neighbors of a reference item, using its property set, or of a desired property set. A query can be specified in terms of a particular item or group of items, or in terms of a set of properties. Additionally, a query that is not formulated as a set of valid properties can be mapped to a reference set of properties to search for the nearest neighbors of the query. The system can determine which item or items are closest, in absolute terms or within a desired degree, to the reference property set under this distance metric. For example, within a distance threshold of 5, the four nearest neighbors of Raiders of the Lost Ark are Indiana Jones and the Temple of Doom and Indiana Jones and the Last Crusade at distance 3 (the absolute nearest neighbors) and Close Encounters of the Third Kind and E. T.: the Extra-Terrestrial at distance 5 (also within the desired degree of 5).

It is possible to compute the nearest neighbors of a property set by computing distances to all items in the collection, and then sorting the items in non-decreasing order of distance. The “nearest” neighbors of the reference property set may then be selected from such a sorted list using several different methods. For example, all items within a desired degree of distance may be selected as the nearest neighbors. Alternatively, a particular number of items may be selected as the nearest neighbors. In the latter case, tie-breaking may be needed select a limited number of nearest neighbors when more than that desired number of items are within a certain degree of nearness. Tie-breaking may be arbitrary or based on application-dependent criteria. The threshold for nearness may be predefined in the system or selectable by a user. An approach based on computing distances to all items in the collection will provide correct results, but is unlikely to provide adequate performance when the collection of items is large.

While the foregoing method for nearest neighbor search applies the distance function explicitly, the distance metric of the present invention may also be applied implicitly, through a method that incorporates the distance metric without necessarily calculating distances explicitly. For example, another method to compute the nearest neighbors of a reference property set is to iterate through its subsets, and then, for each subset, to count the number of items in the collection containing all of the properties in that subset. This method may be implemented, for example, by using a priority queue, in which the priority of each subset is related to the number of items in the collection containing all of the properties in that subset. The smaller the number of items containing a subset of properties, the higher the priority of that subset. The priority queue initially contains a single subset: the complete reference set of properties. On each iteration, the highest priority subset on the queue is provided, and all subsets of the highest priority subset that can be obtained by removing a single property from that highest priority subset are inserted onto the queue. This method involves processing all subsets of properties in order of their distance from the original property set. The method may be terminated once a desired number of results or a desired degree of nearness has been reached.

The following example illustrates an application of this priority queue method for searching for the nearest neighbors of a query based on a movie in accordance with an embodiment of the invention using the movies catalog discussed earlier. The movie E. T.: the Extra Terrestrial may be selected from this catalog as the desired reference movie or target for which a similarity search is being formed in the movie catalog. In the catalog, this movie has the following 6 properties:

Director: Stephen Spielberg

Star: Dee Wallace-Stone

Star: Henry Thomas

Genre: Family

Genre: Sci-Fi

Genre: Adventure

In this example, the actors are disregarded, leaving the director and genre(s) as the desired reference properties. Hence, the target movie has the following 4 reference properties that compose the query for this search: {Spielberg, Family, Sci-Fi, Adventure}.

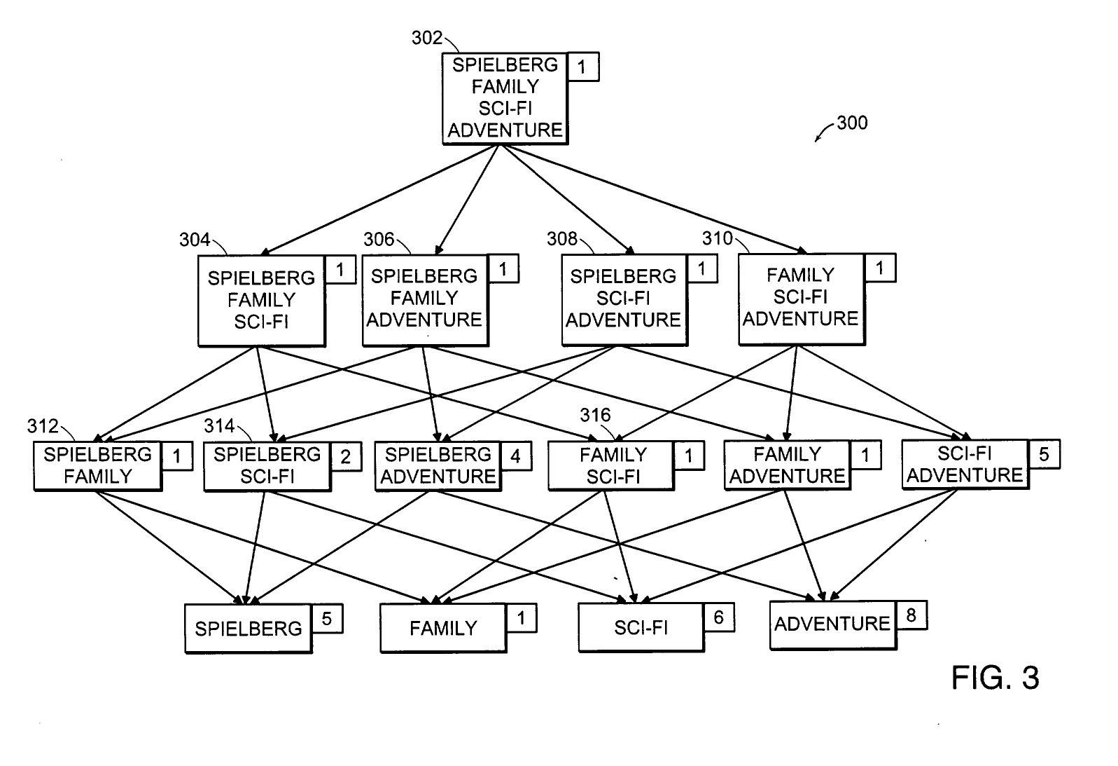

FIG. 3 shows, as a directed acyclic graph 300, the set of all subsets of these four properties. The number to the right of each box shows the number of movies containing all properties in the subset.

To perform the similarity search using this priority queue method, the queue initially contains only one subset-namely, the set of all 4 properties 302, Spielberg, Family, Sci-Fi, and Adventure. This subset has a priority of 1, since only one movie, i.e., the reference movie, contains all 4 properties. The lower the number of movies, the higher the priority; hence, 1 is the highest possible priority.

If the distance is defined as equal to the number of movies that share the intersection of properties in two property sets, the priority of a subset is exactly equal to the distance of the subset from the query in this implementation. Otherwise, in accordance with the distance metric of the present invention, the priority is correlated to the distance of the subset from the query. Although the priorities of all subsets could be computed in accordance with FIG. 3 prior to implementing the priority queue, the priority of a subset may be computed when the subset is added to the queue. Also, movies can be added to the search result when the first subset associated with the movie is removed from the queue.

When this set of 4 properties 302 is removed from the priority queue, it is replaced by 4 subsets of 3 properties 304, 306, 308 and 310; these are shown in the second level from the top in FIG. 3. In this example, each of the four subsets 304, 306, 308 and 310 still only returns the single target movie and all of these subsets also have priority 1.

When, however, the priority-1 subset {Spielberg, Family, Sci-Fi} 304 is removed from the queue, it will be replaced by 3 subsets 312, 314, and 316: {Spielberg, Family} and {Family, Sci-Fi) each with priority 1 and {Spielberg, Sci-Fi} with priority 2. When this last set 316 is eventually removed from the queue, the Spielberg Sci-Fi movie Close Encounters of the Third Kind can be added to the search result.

Since, on each iteration a highest priority (fewest movies) subset is chosen from the queue, subsets will be chosen in decreasing order of priority. Hence, movies will show up in increasing order of distance from the query. The process can be terminated when a threshold number of search results have been found, or when a threshold distance has been reached, or when all of the subsets have been considered. For efficiency, to avoid evaluating the same subset more than once, when subsets are pushed onto the queue, the system can eliminate those that have already been seen. In general this type of method may not provide adequate performance for computing the nearest neighbors of a large property set.

Implementations that compute the nearest neighbors of a property set without necessarily computing its distance to every item in the collection or every subset of the property set may be more efficient. In particular, if the collection is large, preferred implementations may only consider distances to a small subset of the items in the collection or a small subset of the properties. Some embodiments of the present invention compute the nearest neighbors of a property set by using a random walk process. This approach is probabilistic in nature, and can be tuned to trade-off accuracy for performance.

Each iteration of the random walk process simulates the action of a user who starts from the empty property set and progressively narrows the set towards a target property set S along a randomly selected path. The simulated user, however, may stop mid-task at an intermediate subset of S and then randomly pick an item that has all of the properties in that intermediate subset. Items closer to the target property set S according to the previously described distance function are more likely to be selected, since they are more likely to remain in the set of remaining items as the simulated user narrows the set of items by selecting properties.

One implementation of the random walk process produces a random variable R(S) for a property set S with the following properties:

1. The range of R(S) is the set of items {x₁, x₂, . . . , xₙ} in the collection.

2. Pr(R(S)=xᵢ)>0 for all items xᵢin the collection. (i.e., for every item xᵢin the collection, there is a non-zero probability that R(S) takes on the property xᵢ)

3. Pr(R(S)=xᵢ)≧Pr(R(S)=xⱼ) if and only if dist(S, xᵢ)≦dist(S, xⱼ). (i.e., the probability that R(S) takes on the property x is a monotonic function of the distance dist (S, x))

The random variable is weighted towards xᵢwith property sets that are relatively closer to the property set S.

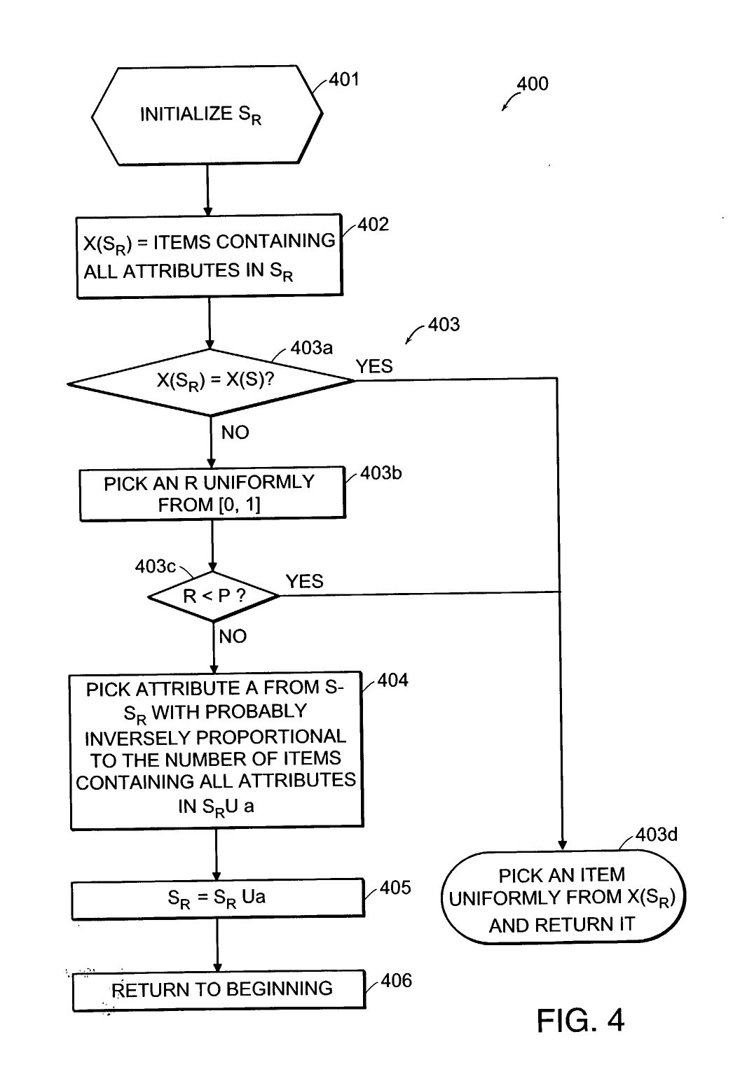

The property set S is the reference property set for a similarity search. A number of random walk processes may be able to generate a random variable R(S) with a distribution satisfying these properties as described above. A random walk process 400 in accordance with embodiments of the invention is illustrated in the flow chart of FIG. 4. The states of this random walk 400 are property sets, which may correspond to items in the collection. The random walk process 400 proceeds as follows:

Step 401: Initialize S_{R}, the state of the random walk, to be the empty property set.

Step 402: Let X(S_{R}) be the subset of items in the collection containing all of the properties in S_{R}.

Step 403: If X(S_{R})=X(S) then, in step 403a, or, with probability p, determined in steps 403b and 403c, using a uniform random distribution, choose an item from X(S_{R}) and return it in step 403d, thus terminating the process.

Step 404: Otherwise, pick a property from S-S_{R}—that is, the set of properties that are in S but not in S_{R}. This property is picked using a probability distribution where the probability of picking property a from S-S_{R} is inversely proportional to the number of items in the collection that contain all the properties in the union S_{R}∪a.

Step 405: Let S_{R} equal S_{R}∪a.

Step 406: Go back to Step 402.

The item returned by each iteration of this random walk process will be a random variable R(S) whose distribution satisfies the properties outlined above. The output of multiple, independent iterations of this process will converge to the distribution of this random variable. Each iteration of the random walk process implicitly uses the distance metric of the present invention in that, for a property set S_{R}, the random walk inherently selects items within a certain distance of S. In step 403, a random walk terminates with probability p, except where the entire collection has already been traversed. Probability p is a parameter that may be selected based on the desired features, particularly accuracy and performance, of the system. If p is small, any results will be relatively closer to the reference, but the process will be relatively slow. If p is large, any results may vary further from the reference, but the process will be relatively faster.

Using this random walk process, it is possible to determine the nearest neighbors of a property set by performing multiple, independent iterations of the random walk process, and then sorting the returned items in decreasing order of frequency. That is, the more frequently returned items will be the nearer neighbors of the reference property set. The nearest neighbors may be selected in accordance with the desired degree of nearness. The choice of the parameter p in the random walk process and the choice of the number of iterations together allow a trade-off of performance for accuracy.

The following example illustrates an application of this random walk method for the E. T. example presented earlier using the priority queue method. Again, the query is formulated as the set of the following 4 properties: {Spielberg, Family, Sci-Fi, Adventure}. Recall that FIG. 3 shows, as a directed acyclic graph 300, the set of all subsets of these four properties.

S_{R}, the state of the random walk, is initialized to be the empty property set. X(S_{R}), the subset of items in the collection containing all of the properties in S_{R}, is the set of all 15 movies in the collection. Obtaining a randomly generated number between 0 and 1, if the random number is less than p, then one of these 15 movies is selected at random and returned.

Otherwise, a property from S-S_{R}—that is, the set of properties that are in the target set S but are not in S_{R}—is selected and added to S_{R}. Since S_{R} is empty, a property is selected from {Spielberg, Family, Sci-Fi, Adventure}. This property is selected using a probability distribution where the probability of selecting property a from S-S_{R} is inversely proportional to the number of items in the collection that contain all of the properties in the union S_{R}∪a. Hence, Spielberg is selected with probability inversely proportional to 5; Family with probability inversely proportional to 1; Sci-Fi with probability inversely proportional to 6; and Adventure with probability inversely proportional to 8. Normalizing, we obtain the following probability distribution: Spielberg has probability 24/179; Family has probability 120/179; Sci-Fi has probability 20/179; and Adventure has probability 15/179.

If Family is picked, then E. T. will be returned, since it will be the only movie left in X(S_{R}). Continuing the process with Spielberg selected, now S_{R} is {Spielberg}, and X(S_{R}) contains the 5 Spielberg movies. If a new randomly generated number is less than p, then one of these 5 movies is selected at random and returned.

Otherwise, another property from S-S_{R} selected and added to S_{R}. Since S_{R} is {Spielberg}, the property is selected from {Family, Sci-Fi, Adventure}, as follows: Family with probability inversely proportional to 1 (1 movie corresponds to {Spielberg, Family}); Sci-Fi with probability inversely proportional to 2 (2 movies correspond to {Spielberg, Sci-Fi}); and Adventure with probability inversely proportional to 4 (4 movies correspond to {Spielberg, Adventure}). Normalizing, we obtain the following probability distribution: Family has probability 4/7; Sci-Fi has probability 2/7; and Adventure has probability 1/7.

Again, if Family is picked, then E. T. will be returned, since it will be the only movie left in X(S_{R}). Assuming that Sci-Fi is selected, now S_{R} is {Spielberg, Sci-Fi}, and X(S_{R}) contains the 2 movies with these two properties. If a new randomly generated number is less than p, then one of these 2 movies is selected at random and returned.

Otherwise, the subsequent selection of either Family or Adventure ensures that E. T. will be returned.

The random walk process may be iterated as many times as appropriate to provide the desired degree of accuracy with an acceptable level of performance. The results of the random walk process are compiled and ranked according to frequency. Items with higher frequencies within a desired threshold can be selected as the nearest neighbors of the query.

The present invention provides a general solution for the similarity search problem, and admits to many varied embodiments, including variations designed to improve performance or to constrain the results.

One variation for performance is particularly appropriate when the similarity search is being performed on a reference item x in the collection. In that case, it is useful for the similarity search not to return the item itself. This variation may be accomplished by changing step 403 of the random walk process. Instead of randomly choosing an item from X(S_{R}), the step randomly chooses an item from X(S_{R})−x. Under these conditions, it is possible that a particular iteration of the process will terminate without returning an item, because X(S_{R})−x may be empty. Over a number of successive iterations, however, the random walk process should return items.

Another variation is to replace the condition in step 403, termination with probability p, with a condition that the process terminates when X(S_{R}) is below a specified threshold size. One advantage of this implementation is that it is no longer necessary to tune p. Another variation is to replace the behavior in step 403 (returning an item chosen from X(S_{R}) using a uniform random distribution) with returning all or some of the items in X(S_{R}). One advantage of this implementation is that individual iterations of the random walk process produce additional data points.

Another variation is to constrain the random walk by making the initial state non-empty. Doing so ensures that the process will only return items that contain all of the properties in the initial state. Such constraints may be useful in many applications.

Another variation is to use the above described method for similarity search in conjunction with other similarity search measures, such as similarity search measures based on Euclidean distance, in various ways. For example, similarity search could be performed for a particular reference using both a distance metric in accordance with the present invention and a geometric distance metric on the same collection of materials, and the outcomes merged to provide a result for the search. Alternatively, a geometric distance metric could be used to compute an initial result and the distance metric of the present invention could be used to analyze the initial result to provide a result for the search. The invention may also be implemented in a system that incorporates other search and navigation methods, such as free-text search, guided navigation, etc.

Another variation is to group properties into equivalence classes, and to then consider properties in the same equivalence class identical in computing the distance function. The equivalence classes themselves may be determined by applying a clustering algorithm to the properties.

The similarity search aspect of the present invention is useful for almost any application where similarity search is needed or useful. The present invention may be particularly useful for merchandising, data discovery, data cleansing, and business intelligence.

The distance metric of the present invention is useful for applications in addition to similarity search, such as clustering and matching. The clustering problem involves partitioning a set of items into clusters so that two items in the same cluster are more similar than two items in different clusters. There are numerous mathematical formulations of the clustering problem. Generally, a set S of n items i₁, i₂, . . . , iₙ, and these items is to be partitioned into a set of k clusters C₁, C₂, . . . , Cₖ—where the number of clusters k is generally specified in advance, but may be determined by the clustering algorithm.

Since there are many feasible solutions to the clustering problem, a clustering application defines a function that determines the quality of a solution, the goal being to find a feasible solution that is optimal with respect to that function. Generally, this function is defined so that quality is improved either by reducing the distances between items in the same cluster or by increasing the distances between items in different clusters. Hence, solutions to the clustering problem typically use a distance function to determine the distance between two items. Traditionally, this distance measure is Euclidean. In another aspect of the present invention, clustering algorithms can be based on the distance function of the present invention.

The following are examples of quality functions, with an indication afterwards as to whether they should be minimized or maximized to obtain high-quality clusters:

The maximum distance between two items in the same cluster (minimize).

The average (arithmetic mean) distance between two items in the same cluster (minimize).

The minimum distance between two items in different clusters (maximize).

The average (arithmetic mean) distance between two items in different clusters (maximize).

The quality function may be one of the above functions, or some other function that reflects the goal that items in the same cluster be more similar than items in different clusters.

The similarity search method and system of the present invention can be used to define and compute the distance between two items in the context of the clustering problem. The clustering problem is often represented in terms of a graph of nodes and edges. The nodes represent the items and the edges connecting nodes have weights that represent the degree of similarity or dissimilarity of the corresponding items. In this representation, a clustering is a partition of the set of nodes into disjoint subsets. In the graph representation of the clustering problem, the similarity search system may be used to determine the edge weights of such a graph. Once such weights are assigned (explicitly or implicitly), known clustering algorithms can be applied to the graph. More generally, the distance function of the present invention can be used in combination with any clustering algorithm, exact or heuristic, that defines a quality function based on the distances among items.

The clustering problem is generally approached with combinatorial optimization algorithms. Since most formulations of the clustering problems reduce to NP-complete decision problems, it is not believed that there are efficient algorithms that can guarantee optimal solutions. As a result, most clustering algorithms are heuristics that have been shown—through analysis or empirical study—to provide good, though not necessarily optimal, solutions.

Examples of heuristic clustering algorithms include the minimal spanning tree algorithm and the k-means algorithm. In the minimal spanning tree algorithm, each item is initially assigned to its own cluster. Then, the two clusters with the minimum distance between them are fused to form a single cluster. This process is repeated until all items are grouped into the final required number of clusters. In the k-means algorithm, the items are initially assigned to k clusters arbitrarily. Then, in a series of iterations, each item is reassigned to the cluster that it is closest to. When the clusters stabilize—or after a specified number of iterations—the algorithm is done.

Both the minimal spanning tree algorithm and the k-means algorithm require a computation of the distance between clusters—or between an item and a cluster. Traditionally, this distance measure is Euclidean. The distance measure of the present invention can be generalized for this purpose in various ways. The distance between an item and a cluster can be defined, for example, as the average, minimum, or maximum distance between the item and all of the items in the cluster. The distance between two 25 clusters can be defined, for example, as the average, minimum, or maximum distance between an item in one cluster from the other cluster. As with the quality function, there are numerous other possible item-cluster and cluster-cluster distance functions based on the item-item distance function that can be used depending on the needs of a particular clustering application.

In some variations of clustering, the clusters are allowed to overlap—that is, the items are not strictly partitioned into clusters, but rather an item may be assigned to more than one cluster. This variation expands the space of feasible solutions, but can still be used in combination with the quality and distance functions described above.

In order to improve the performance of a clustering algorithm, it may desirable to sparsify the graph by only including edges between nodes that are relatively close to each other. One way to implement this sparsification is to compute, for each item, its set of nearest neighbors, and then to only include edges between an item and its nearest neighbors.

An application of clustering with respect to the invention is to cluster the properties relevant to a set of items to generate equivalence classes of properties for similarity search. The clustering into equivalence classes can be performed using the distance metric of the present invention. To apply the distance metric of the present invention, the properties themselves can be associated with sub-properties so that the properties are treated as items for calculating distances between them. One subproperty that may be associated with the properties, for example, is the items in the collection with which the properties are originally associated. The matching problem involves pairing up items from a set of items so that a pair of items that are matched to each other are more similar than two items that are not matched to each other. There are two kinds of matching problems: bipartite and non-bipartite. In a bipartite matching problem, the items are divided into two disjoint and preferably equal-sized subsets; the goal is to match each item in the first subset to an item in the second subset. In the graph representation of the clustering problem, this case corresponds to a bipartite graph. In a non-bipartite, or general, matching problem, the graph is not divided, so that an item could be matched to any other item.

The previously described clustering approaches incorporating the present invention can be used for non-bipartite matching. Generally, if there are n items (n preferably being an even number), they will be divided into n/2 clusters, each containing 2 items.

In accordance with another aspect of the invention, for bipartite matching algorithms that involve the use of a distance function, the input graph may be constructed by creating a node for each item, and defining the weight of the edge connecting two items to be the distance between the two items in accordance with the distance function of the present invention. The matching can then be carried out in accordance with the remaining steps of the known algorithms.

As with clustering, it is possible to use sparsification to improve the performance of a matching algorithm—that is, by only including edges between nodes that are relatively close to each other. This sparsification can be implemented by computing, for each item, its set of nearest neighbors, and then to only include edges between an item and its nearest neighbors.

The foregoing description has been directed to specific embodiments of the invention. The invention may be embodied in other specific forms without departing from the spirit and scope of the invention. In particular, the invention may be applied in any system or method that involves the use of a distance function to determine the distance between two items or subgroups of items in a group of items. The items may be documents or records in a database, for example, that are searchable by querying the database. A system embodying the present invention may include, for example, a human user interface or an applications program interface. The embodiments, figures, terms and examples used herein are intended by way of reference and illustration only and not by way of limitation. The scope of the invention is indicated by the appended claims and all changes that come within the meaning and scope of equivalency of the claims are intended to be embraced therein.

What is claimed is:

1. A method for searching a collection of items, wherein each item in the collection has a set of properties, comprising the steps of:
obtaining a query composed of a first set of one or more properties; and
obtaining a result based on applying a distance function to one or more of the items in the collection, wherein
the distance function determines a distance between the query and an item in the collection based on the number of items in the collection that are associated with all of the properties in the intersection of the first set of properties and the set of properties for the item.

2. The method of claim 1, further including the step of associating each item in the collection with a set of properties.

3. The method of claim 1, wherein the step of obtaining a result includes identifying result items whose distance from the query is within a first threshold.

4. The method of claim 3, wherein the step of obtaining a result includes ranking the result items according to their distance from the query.

5. The method of claim 3, wherein the threshold is defined as a number of result items.

6. The method of claim 3, wherein the threshold is defined as a distance.

7. The method of claim 1, further including the step of returning the result.

8. The method of claim 1, wherein the step of obtaining a query includes the step of mapping a received query to a set of one or more properties.

9. The method of claim 1, wherein one or more of the properties are binary.

10. The method of claim 1, wherein one or more of the properties are related by a partial order, and wherein, if an item is associated with a property, then the item is also associated with all ancestors of that property in the partial order.

11. The method of claim 6, wherein one or more of the properties represent numerical values or ranges, and wherein the partial order reflects a set of containment relationships among the numerical values or ranges.

12. The method of claim 1, wherein the properties are grouped into equivalence classes.

13. The method of claim 12, further including the step of grouping the properties into equivalence classes using clustering.

14. The method of claim 13, wherein each property has a set of subproperties, wherein the clustering is performed such that the distance between two properties in the collection is correlated to the number of properties in the collection that are associated with all of the subproperties common to both properties.

15. The method of claim 1, wherein the query corresponds to a single item in the collection.

16. The method of claim 1, wherein the query corresponds to a plurality of items in the collection.

17. The method of claim 1, wherein the query is independent of the items in the collection.

18. The method of claim 1, wherein the step of obtaining a result is constrained to a subcollection of the items in the collection.

19. The method of claim 18, wherein the subcollection is specified as an expression of properties.

20. The method of claim 19, wherein the expression includes a subset of the set of properties that compose the query.

21. The method of claim 1, wherein the step of obtaining a query includes identifying certain properties to be ignored in the step of obtaining a result.

22. The method of claim 1, wherein the distance function is applied explicitly.

23. The method of claim 1, wherein the distance function is applied implicitly.

24. The method of claim 23, wherein the step of obtaining a result includes the step of iterating a random walk process to select potential result items.

25. The method of claim 24, wherein the step of obtaining a result includes ranking the potential result items by frequency and selecting the potential result items having higher frequencies.

26. The method of claim 23, wherein the step of obtaining a result includes iterating through one or more subsets of the query and identifying items associated with the one or more subsets.

27. The method of claim 26, wherein the one or more subsets are prioritized according to the number of items in the collection that have all of the properties in each subset and wherein iterating through one or more subsets of the query is continued until a first threshold is reached.

28. The method of claim 1, wherein the step of obtaining a result includes applying a Euclidean distance function.

29. The method of claim 28, wherein the step of obtaining a result includes merging a first result determined by applying the distance function and a second result determined by applying the Euclidean distance function.

30. The method of claim 28, wherein the step of obtaining a result includes determining a first result by applying either the distance function or the Euclidean distance function and applying the other distance function to the first result.

31. A method for analyzing two sets of properties from a plurality of sets of properties, comprising the steps of:
determining a set of common properties in the intersection of the two sets of properties;
determining the number of sets of properties from the plurality of sets of properties that include the set of common properties; and
assessing the distance between the two sets of properties as a function of the number of sets of properties that include the set of common properties.

32. A method for analyzing the relationship between two items in a collection of items, wherein each item in the collection is associated with a set of properties, comprising the steps of:
obtaining a set of properties with which the two items are commonly associated; and
determining the degree of commonality between the two items as a function of the number of items in the collection that are associated with all of the properties with which the two items are commonly associated.

33. A computer program product, residing on a computer readable medium, for use in searching a collection of items, the computer program product comprising instructions for causing a computer to:
receive a query composed of one or more properties; and
obtain a result based on applying a distance function to one or more items in the collection, wherein
the distance function determines a distance between the query and an item in the collection based on the number of items in the collection that are associated with all of the properties in the intersection of the first set of properties and the set of properties for the item.

34. The computer program product of claim 33, wherein the instructions cause the computer to obtain a result by identifying exactly the items whose distance from the query is within a threshold.

35. The computer program product of claim 33, wherein the instructions cause the computer to obtain a result by identifying approximately the items whose distance from the query is within a threshold according to a heuristic.

36. The computer program product of claim 35, wherein the heuristic permits a trade-off between the accuracy and the performance of a search.

37. The computer program product of claim 35, wherein the heuristic includes the use of a random walk process.

38. A computer system for managing data records comprising:
an information retrieval subsystem that stores and retrieves data records, each data record being associated with a set of properties; and
a similarity search subsystem that receives similarity search queries and processes similarity search queries based on a distance function, a similarity search query being associated with a first set of properties, wherein
the distance function determines a distance between the query and a data record in the collection based on the number of data records in the collection that are associated with all of the properties in the intersection of the first set of properties and the set of properties for the data record.

39. The computer system of claim 38, further including a clustering subsystem that employs the distance function of the similarity search subsystem to construct a graph.

40. A method for applying a matching algorithm to a collection of items, each item being associated with a set of properties, comprising the steps of:
constructing a graph having nodes that correspond to items, and having edges that correspond to pairs of items, wherein each edge has a cost correlated to the number of items in the collection that are associated with all of the properties in the intersection of the sets of properties for the two items that the edge links; and
identifying a subset of the edges that constitutes a minimum-cost matching with respect to the graph.

41. A method for applying a clustering algorithm to a collection of items, each item being associated with a set of properties, comprising the steps of:
constructing a graph having nodes that correspond to items, and having edges that correspond to pairs of items, wherein each edge has a cost correlated to the number of items in the collection that are associated with all of the properties in the intersection of the sets of properties for the two items that the edge links; and
identifying a collection of subsets of the edges that constitutes a minimum-cost clustering with respect to the graph.
